(19) United States
(12) Patent Application Publication
(10) Pub. No.: US 2021/0053600 A1
(43) Pub. Date: Feb. 25, 2021

(54) FOLDABLE MULTIPLE-FUNCTION CART

(71) Applicant: ILLINOIS ENTERPRISES CO., TAICHUNG CITY (TW)

(72) Inventors: WEN-FA WANG, TAICHUNG CITY (TW); HSIN-HUNG LIN, TAICHUNG CITY (TW)

(21) Appl. No.: 16/543,791

(22) Filed: Aug. 19, 2019

(51) Int. Cl. B62B 3/02; B62B 5/00

(52) U.S. Cl. CPC B62B 3/02; B62B 5/0023

(57) ABSTRACT

A multiple-function cart includes a main body, a handle, a tail board, four wheel sets and a strap unit. The main body includes a front portion pivotably connected to a rear portion by a first pivotal unit. The front portion is pivoted relative to the rear portion by the first pivotal unit. The handle is pivotably connected to the rear portion by two second pivotal units and is pivotable about the first pivotal unit. The four wheel sets are respectively connected to the front and rear portion. The strap unit is connected to the handle and includes a strap. The tail board is pivotably connected to the front portion so as to be parallel or perpendicular to the front portion. The cart can be carried on the user's back or used as a normal cart on the ground.

### BACKGROUND OF THE INVENTION

### 1. Fields of the Invention

The present invention relates to a cart, and more particularly, to a foldable multiple-function cart.

### 2. Descriptions of Related Art

A conventional multiple-function cart known to applicant includes two mail bodies and a sub body, wherein each of the two main bodies and the sub body has a deck, and the sub body includes rails along which the two main bodies are movable between a folded position and an expanded position. When the two main bodies are located at the expanded position, the decks of the two main bodies and the deck of the sub body are combined to be a larger deck to load more goods. However, the sub body with two rails has occupies a lot space in order to accommodate the two main bodies, and therefore it may not suitable for most of the users. Besides, the conventional multiple-function cart can only be used as a transverse cart and cannot be used in upright position.

The present invention intends to provide a foldable multiple-function cart which can be used in both transverse and upright positions, and the foldable multiple-function cart of the present invention can be folded to save storage room.

### SUMMARY OF THE INVENTION

The present invention relates to a multiple-function cart and comprises a main body having a front portion and a rear portion which is pivotably connected to the front portion by a first pivotal unit, so that the front portion is pivotable relative to the rear portion by the first pivotal unit. A handle is pivotably connected to the rear portion by two second pivotal units so that the handle is pivotable by the two second pivotal units. Four wheel sets are respectively and pivotably connected to the front portion and the rear portion. Each wheel set has a wheel and a wheel frame, and each wheel set is pivotable between a non-in-use position and an in-use position. When each of the wheel sets is located at the non-in-use position, the wheel sets are parallel with the main body and located at inside of the main body. When each of the wheel sets is located at the in-use position, the wheel sets are perpendicular to the main body. A strap unit has a back board, and the strap unit is connected to the handle by one of two sides of the back board. A strap is connected to the other of the two sides of the back board. A tail board is pivotably connected to the front portion and located away from the rear portion. The tail board is pivotable toward the front portion, or is perpendicular to the front portion.

The primary object of the present invention is to provide a cart which can be carried on the user's back, and also be used in different ways as normal carts.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIGS. 1 and 2 show the cart and the strap unit of the present invention;

FIGS. 3 and 4 show the support frame, the restriction member and the fourth spring of the strap unit;

FIGS. 5 to 7 show the wheel set, the first seat and the restriction part of the cart of the present invention;

FIGS. 8 to 10 shows the relationship of the positioning unit and the dents of the positioning unit;

FIGS. 11 to 13 show various operation statuses of the first pivotal unit;

FIGS. 14 and 15 are enlarged view to show connection between the positioning part and the bolt;

FIG. 16 show the exploded view of the second pivotal unit;

FIGS. 17 to 19 shows various operation statuses of the second pivotal unit;

FIG. 20 shows that the cart is carried on the user's back;

FIG. 21 shows that the cart is transversely used;

FIG. 22 shows steps for transforming the cart from the back carried status to the transverse position;

FIG. 23 shows the cart in the upright position, and

FIG. 24 shows steps for transforming the cart from the back carried status to the upright position.

### DETAILED DESCRIPTION OF THE PREFERRED EMBODIMENT

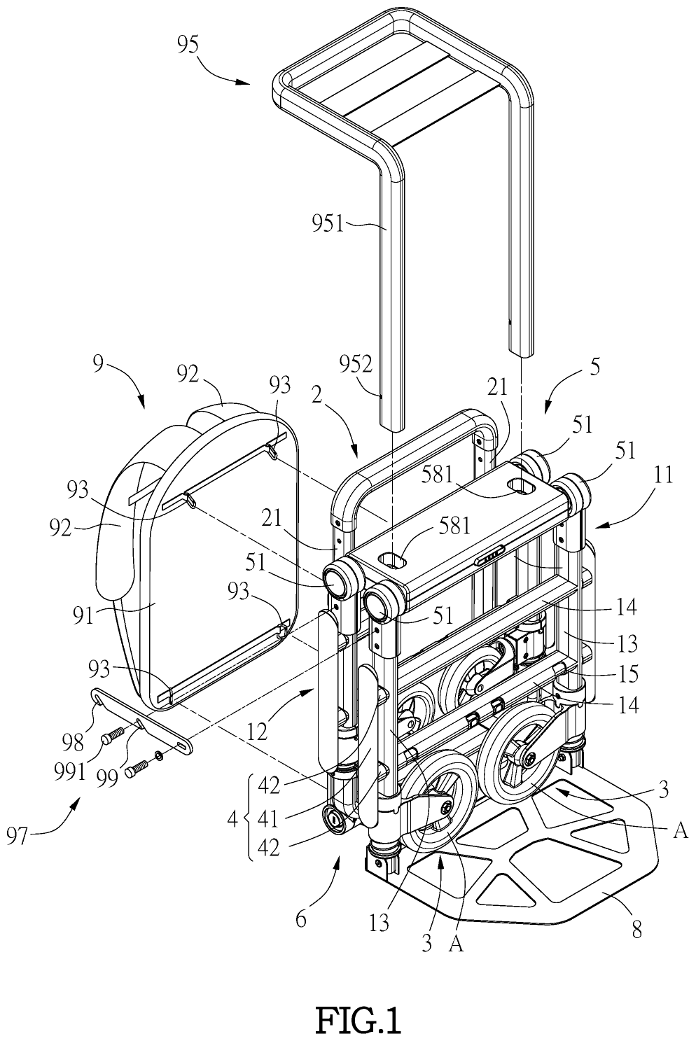

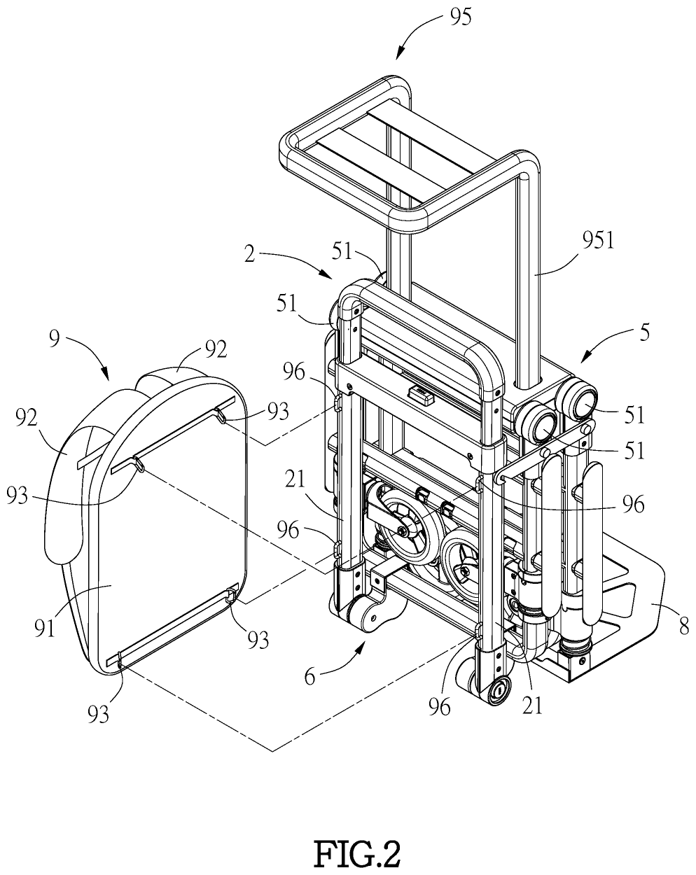

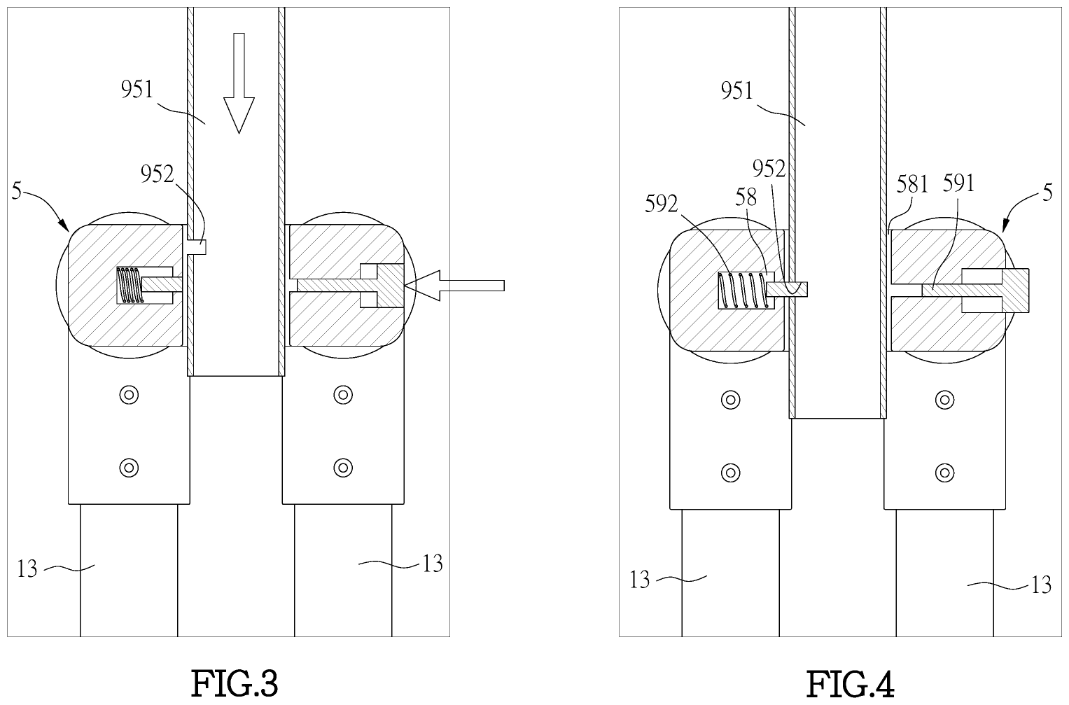

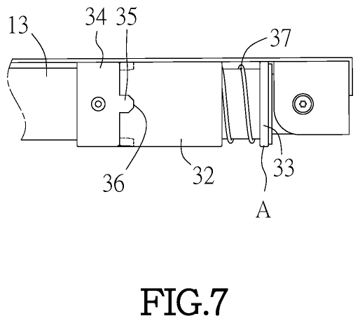

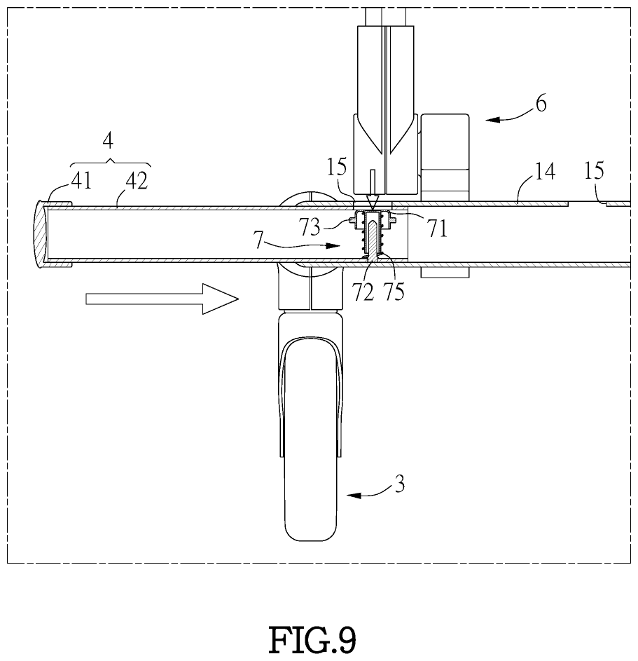

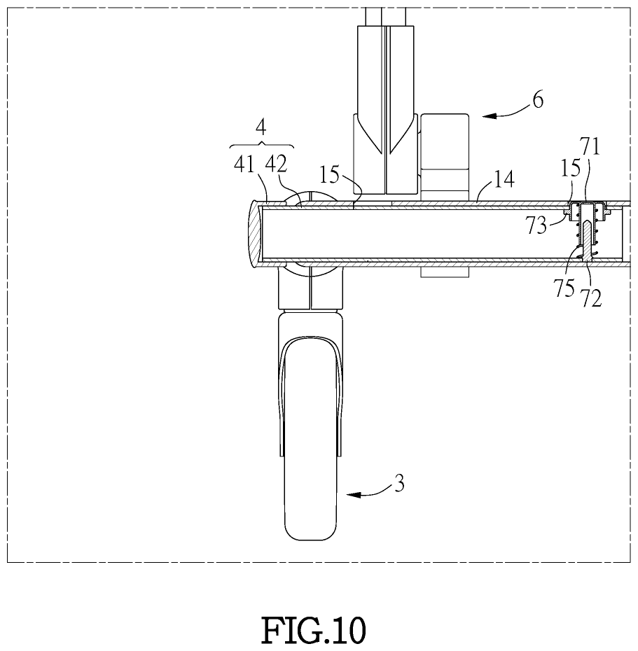

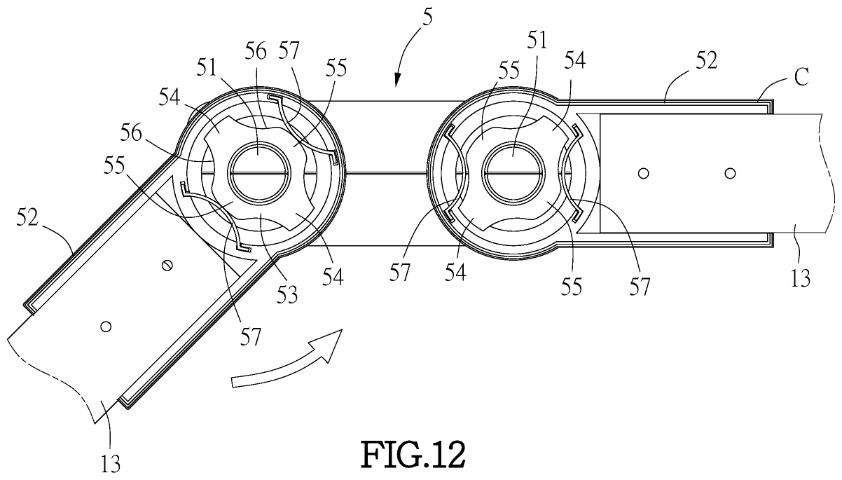

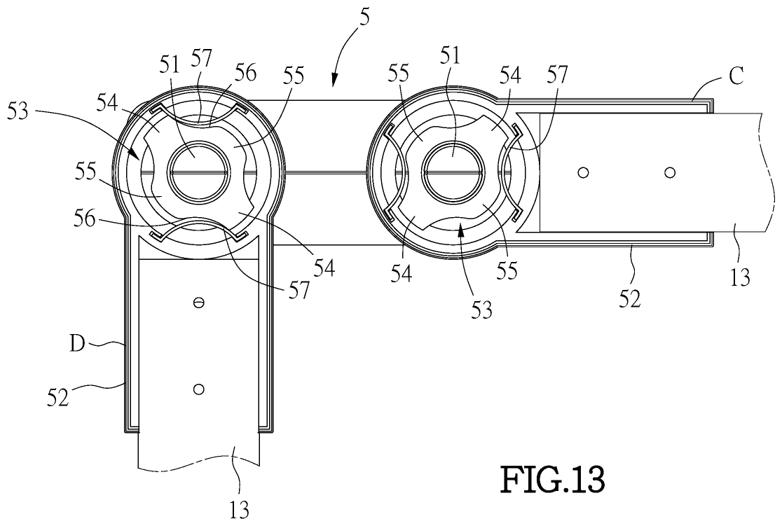

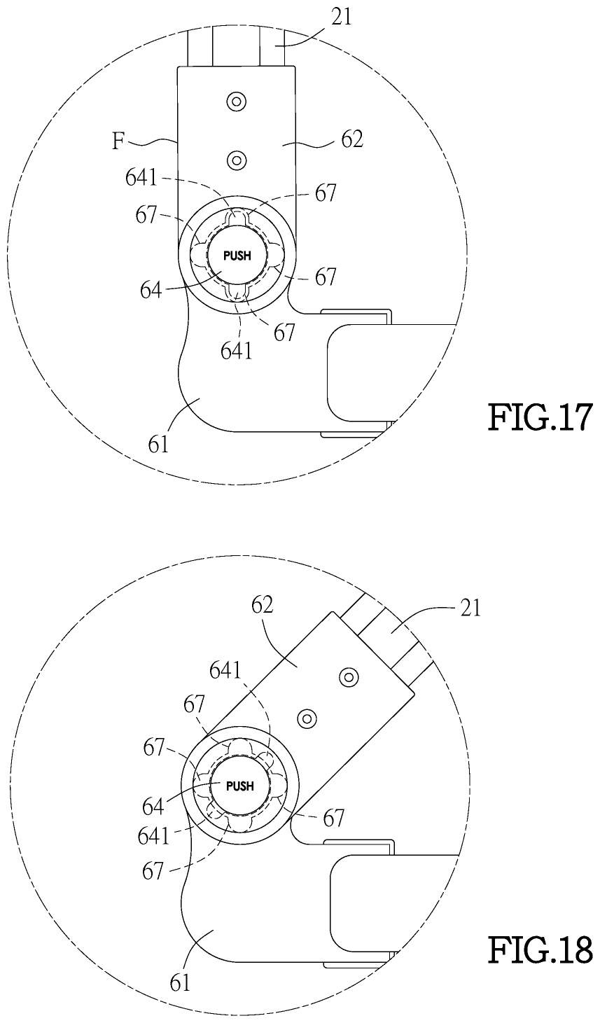

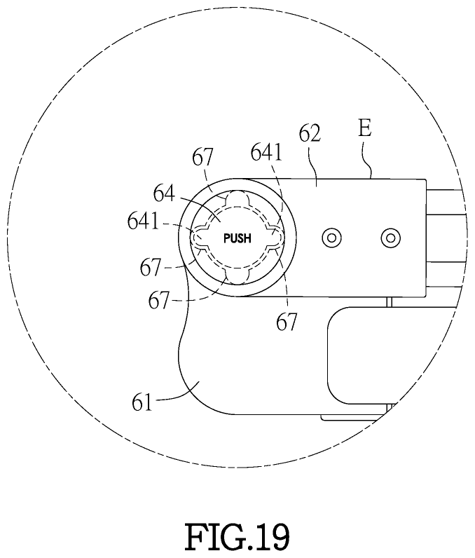

Referring to FIGS. 1 to 24, the multiple-function cart of the present invention comprises a main body, a handle 2, four wheel sets 3, four extension parts 4 and a strap unit 9.

The main body includes a front portion 11 and a rear portion 12 which is pivotably connected to the front portion 11 by a first pivotal unit 5. The front portion 11 is pivotable relative to the rear portion 12 by the first pivotal unit 5. Each of the front portion 11 and the rear portion 21 includes two lateral tubes 13 and two transverse tubes 14 that transversely across the two lateral tubes 13. The two transverse tubes 14 are hollow tubes and each have an end hole (not shown) in each of two ends thereof. At least one of the two transverse tubes 14 has four positioning hole 15.

The handle 2 is a U-shaped handle and includes two connection tubes 21 with a bridge connected between the two connection tubes 21. The two connection tubes 21 are pivotably connected to the rear portion 12 by two second pivotal units 6, so that the handle 2 is pivotable by the two second pivotal units 6.

The strap unit 9 includes a back board 91. The strap unit 9 connected to the handle 2 by one of two sides of the back board 91, and a strap 92 is connected to the other of the two sides of the back board 91. The users carry the cart on their back by the strap 92. In this embodiment, multiple loops 96 are formed on each of the two connection tubes 21. The strap unit 9 includes four hooks 93 which are hooked to the loops 96.

A tail board 8 is pivotably connected to the front portion 11 and located away from the rear portion 12. The tail board 8 is pivotable toward the front portion 11, or is perpendicular to the front portion 11.

The four wheel sets 3 are respectively and pivotably connected to the front portion 11 and the rear portion 12. Each wheel set 3 has a wheel 31 and a wheel frame 32 to which the wheel 31 is connected. Each wheel set 3 is pivotable between a non-in-use position “A” and an in-use position “B”. When each of the wheel sets 3 is located at the non-in-use position “A”, the wheel sets 3 are parallel with the main body and located at inside of the main body. When each of the wheel sets 3 is located at the in-use position “B”, the wheel sets 3 are perpendicular to the main body.

As shown in FIGS. 1 to 3, the first pivotal unit 5 includes a room 58 in which a restriction member 591 and a fourth spring 592 are received. The fourth spring 592 biases the restriction member 591 which includes a portion thereof extending through the room 58 and protrudes beyond the first pivotal unit 5. The first pivotal unit 5 includes two installation holes 581 which communicate with the room 58. A support frame 95 includes two legs 951 which are inserted into the two installation holes 581, and each leg 951 includes a bore 952 with which the restriction member 591 is engaged when the leg 951 is inserted into the installation hole 581 corresponding thereto.

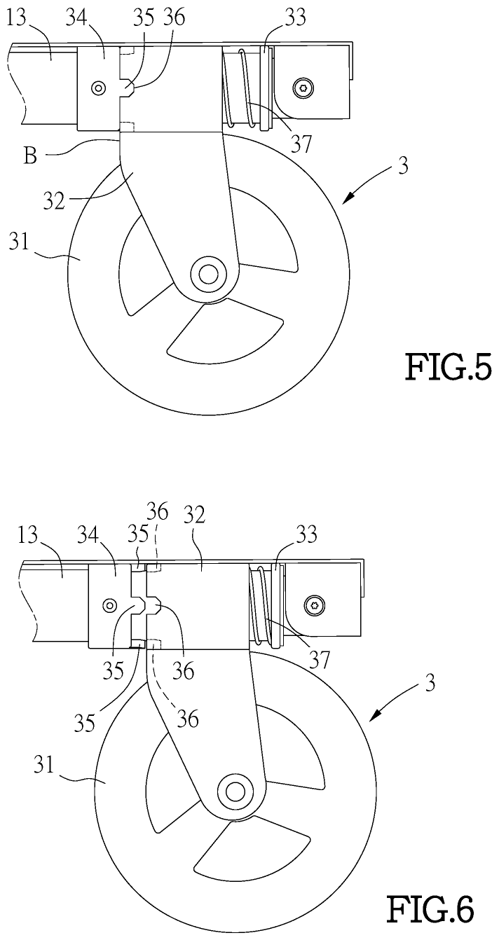

As shown in FIGS. 5 to 7, the wheel frame 32 of each wheel set 3 includes a first seat 33 and a restriction part 34 respectively connected to each lateral tube 13. The wheel frame 32 is pivotably located between the restriction part 34 and the first seat 33. The restriction part 34 includes four protrusions 35, and the wheel frame 32 includes four notches 36 which are located corresponding to the four protrusions 35. A first spring 37 is biased between the wheel frame 32 and the first seat 33 to engage the protrusions 35 with the notches 36 to set the wheel frame 32 at the non-in-use position “A” or the in-use position “B”. Therefore, the wheel frames 32 do not shift or rotate randomly.

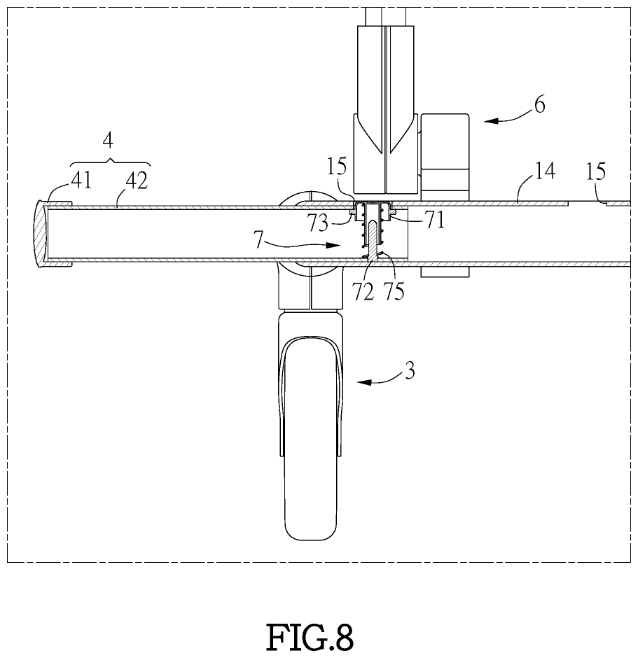

As shown in FIGS. 8 to 10, the two transverse tube 14 are two hollow tubes and the four extension parts 4 each have a lateral rod 41 and two bars 42 which extend from one side of the lateral rod 41. The extension parts 4 are respectively located on two sides of the front portion 11 and the rear portion 12. The bars 42 are slidably inserted in the transverse tubes 14. One of the bars 42 of each extension portion 4 includes a positioning unit 7 which is located corresponding to the at least one positioning hole 15. The positioning unit 7 includes a positioning member 71 and a pin 72. The positioning member 71 includes a stop 73 and an extension portion 74 which is located away from the at least one positioning hole 15. The extension portion 74 is slidably mounted to the pin 72. A second spring 75 is mounted to outside of the extension portion 74, the second spring 75 biases the stop 73 to push the positioning member 71 to move along the pin 72 and toward the positioning hole 15. The stop 73 is located at the positioning hole 15. The stop 73 includes a press portion 76 which protrudes into the positioning hole 15.

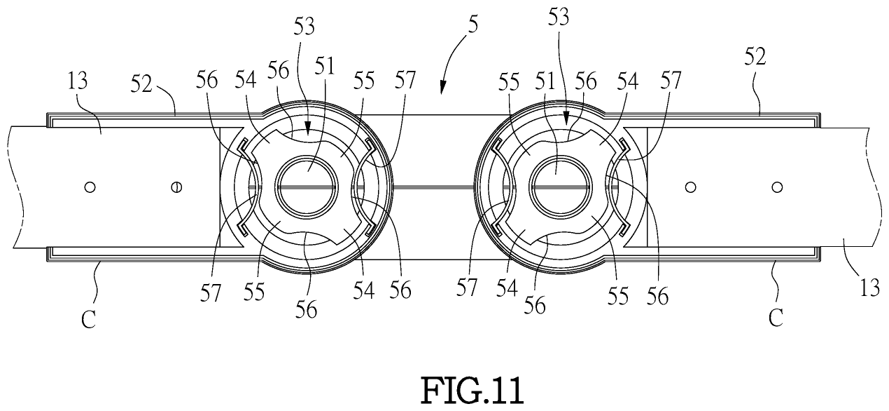

As shown in FIGS. 11 to 13, the first pivotal unit 5 includes four shafts 51, and each shaft 51 is pivotably connected to a second pivotal part 52. Each second pivotal part 52 is connected to the two lateral tube 13 of the front portion 11 and the two lateral tubes 13 of the rear portion 12 so that the front portion 11 and the rear portion 12 are respectively pivotable between an expanded position “C” and a retrieved position “D” by the second pivotal parts 52.

Each of the shafts 51 has a positioning member 53 fixed thereto which has two first bumps 54 and second bumps 55 which are located alternatively to the first bumps 54. A curve recess 56 is formed between each of the first and second bumps 54, 55. The two first bumps 54 extend higher than the two second bumps 55 and are located away from the shafts 51. Each of the second pivotal parts 52 includes two curve steel plates 57 which are located corresponding to the curve recesses 56. When the second pivotal parts 52 are pivoted about the shafts 51 to the expanded position “C”. It is noted that the curve steel plates 57 each have a certain level of flexibility which allows the curve steel plates 57 to move over the second bumps 55, but cannot move rover the first bumps 54. When the second pivotal parts 52 each are located at the expanded position “C”, the curve steel plates 57 are located in the curve recesses 56 and stopped by the first bumps 54, so that the second pivotal parts 52 cannot pivot clockwise about the shafts 51. When the second pivotal parts 52 are pivoted about the shafts 51 to the retrieved position “D”, the curve steel plates 57 are located in the curve recesses 56 and stopped by the first bumps 54, so that the second pivotal parts 52 cannot pivot counter clockwise about the shafts 51.

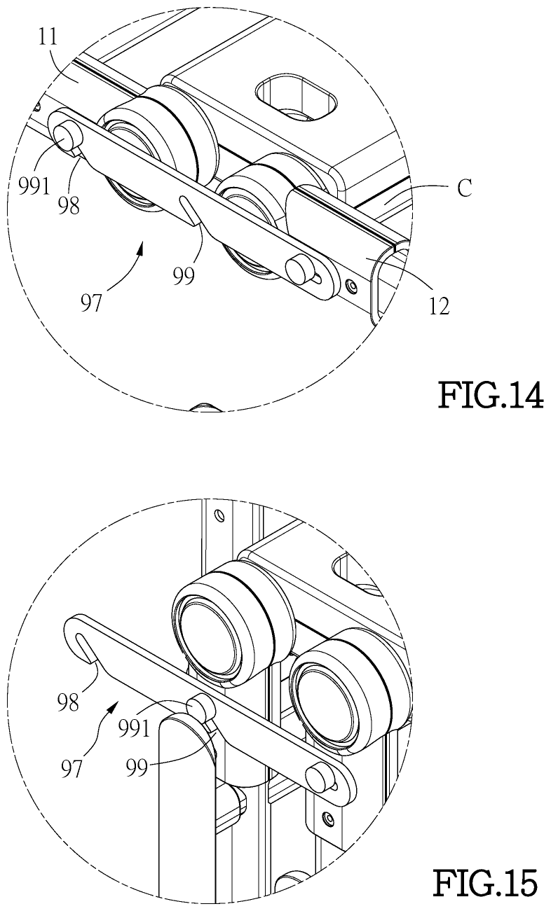

It is noted as shown in FIGS. 14 and 15, the front portion 11 includes a positioning part 97 pivotably connected to one side thereof. The positioning part 97 has a first slot 98 and a second slot 99. The rear portion 12 includes a bolt 991 which is connected to the first slot 98 to set the front portion 11 and the rear portion 12 at the expanded position “C”. When the bolt 991 is connected to the second slot 99, the front portion 11 and the rear portion 12 are set at the retrieved position “D”. By the connection between the bolt 991 and the positioning part 97, the front portion 11 and the rear portion 12 are maintained at the expanded position “C” or the retrieved position “D”, and do not randomly shift and rotate.

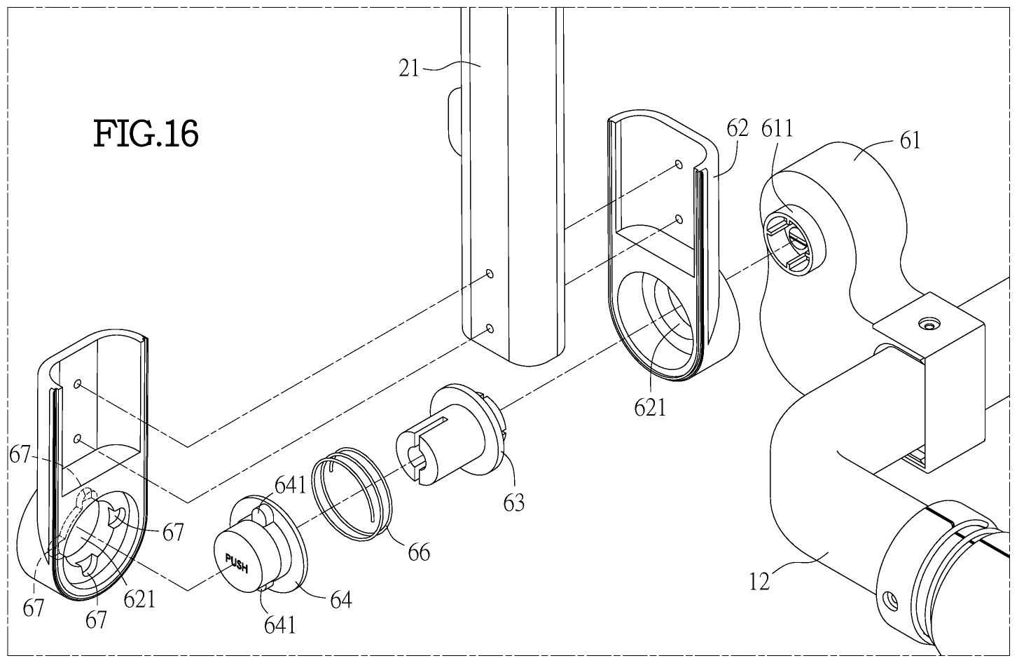

As shown in FIGS. 16 to 19, the two second pivotal units 6 of the handle 2 are connected to the rear portion 12. Each second pivotal unit 6 includes a fixed base 61 and a first pivotal part 62 which is composed of two halves. The two fixed bases 61 are respectively connected to the rear portion 12, and the two first pivotal parts 62 are respectively and pivotably connected to the two fixed bases 61 and connected to the two connection tubes 21 of the handle 2, so that the handle 2 is pivotable about the two fixed bases 61.

The two first pivotal parts 62 each have a chamber defined therein, and two axial holes 621 are respectively defined in two ends of each first pivotal part 62. The two axial holes 621 communicate with the chamber. Each fixed base 61 includes an axle 611 which is pivotably inserted into one of the two axial holes 621 of the first pivotal part 62 corresponding to the fixed base 61 and is secured to a second seat 63 in the chamber. Each second seat 63 has a button 64 slidably mounted thereto. A third spring 66 is biased between the button 64 and the second seat 63 so as to push a portion of the button 64 beyond the other of the two axial holes 621. Each button 64 includes two lugs 641 extending radially therefrom. Four dents 67 are defined in the inner periphery of the chamber of each first pivotal part 62. When each of the first pivotal parts 62 is pivoted about the axial 611 of the fixed base 61 corresponding thereto, the lugs 641 are engaged with the dents 67 to set the handle 2 at a folded position “E”, a transverse position “F” and a upright position “G”.

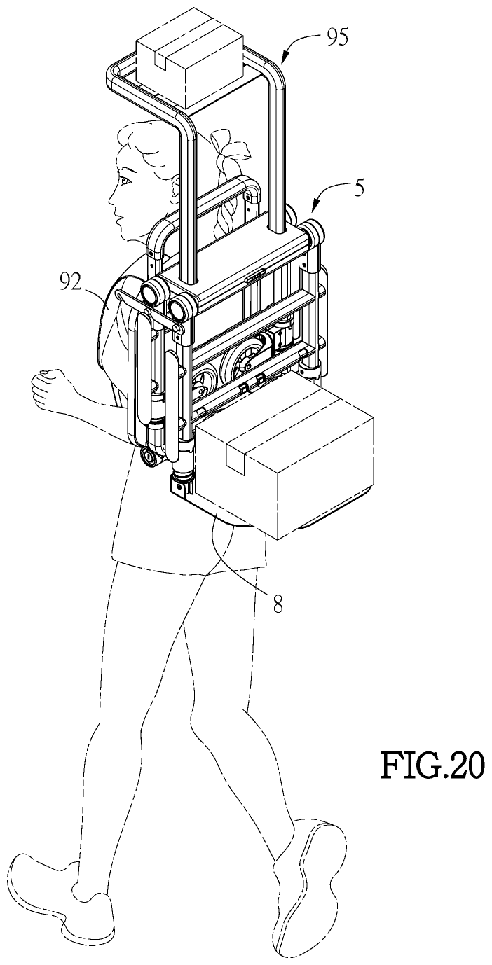

As shown in FIG. 20, the user may carry the cart of the present invention on her back by the strap unit 9. A load is put on the tail board 8 and the support frame 95. This mode allows the user to carry more loads or goods in a narrow space.

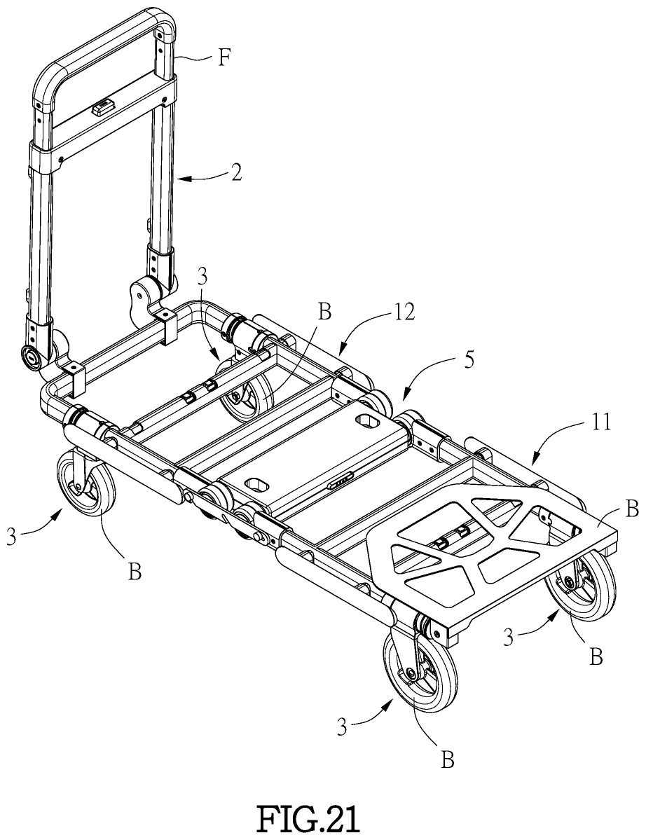

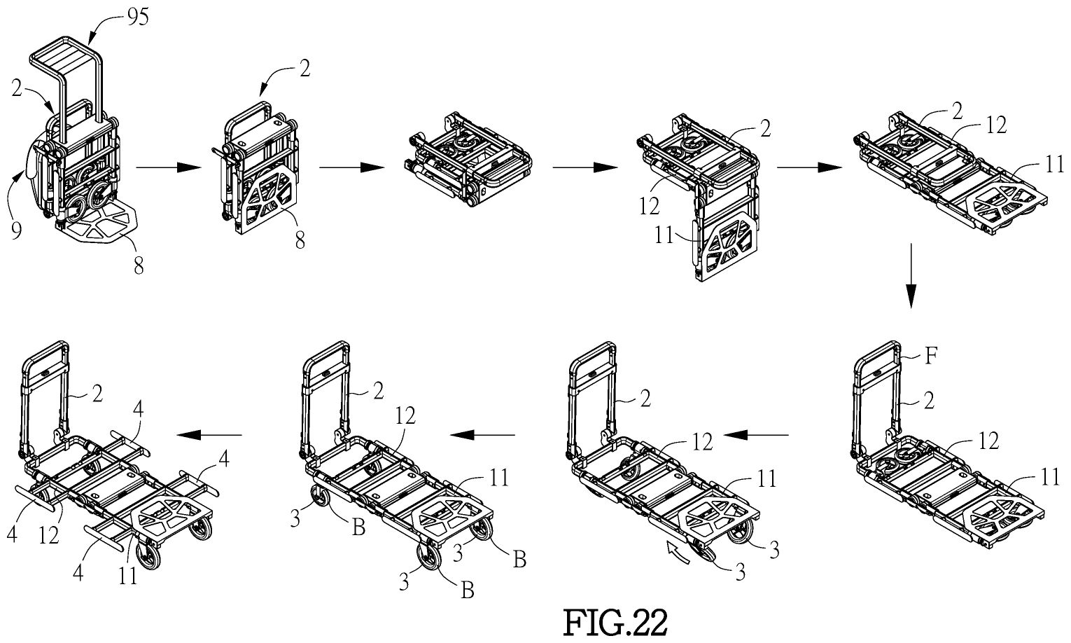

As shown in FIGS. 21 and 22, the user pushes the legs 951 that are exposed beyond the first pivotal unit 5 to remove the legs 951 from the support frame 95. The tail board 8 is then pivoted toward the front portion 11. The front portion 11 is then pivoted about the shaft 51 of the first pivot unit 5 so as to combine the front and rear portions 11, 12 to be a big deck. The handle 2 is pivoted about the fixed bases 61 to a transverse position. The wheel sets 3 are pivoted about the lateral tubes 13 to the in-use position “B”. The user can transport goods on the deck by the cart. Of course, the user may move the extension parts 4 along the transverse tubes 14 by the bars 42 to increase the area of the deck for carrying more goods.

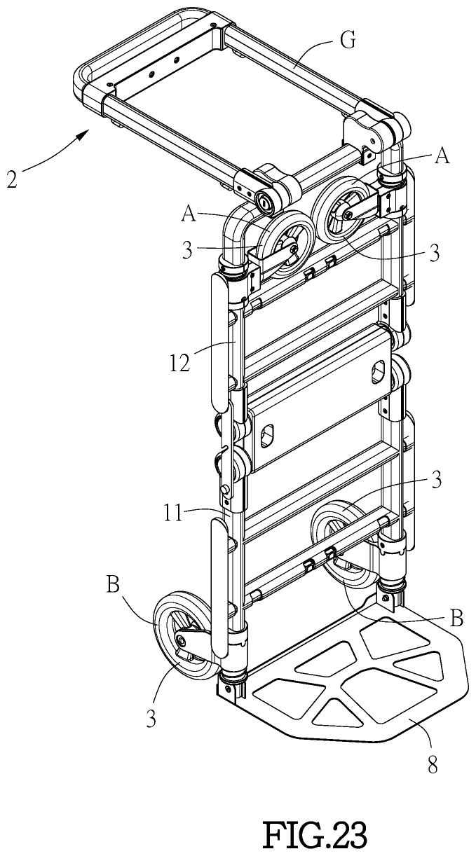

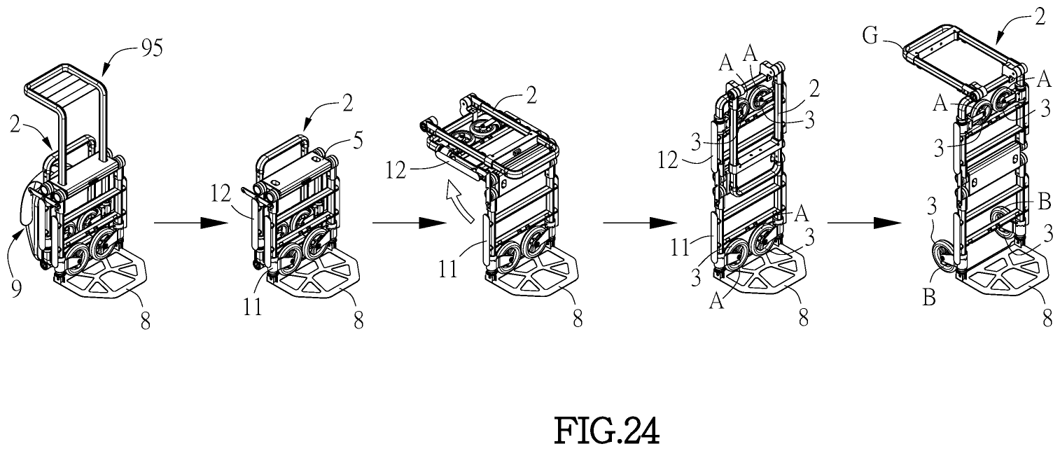

As shown in FIGS. 23 and 24, when the users want use the cart at the upright position, the users pivot the tail board 8 to be perpendicular to the front portion 11, and push the restriction member 591 that is exposed beyond the first pivotal unit 5 to separate the restriction member 591 from the support frame 95, so that the support frame 95 is able to be dismounted. The rear portion 12 is then pivoted about the first pivotal unit 5 to arrange the front ad rear portions 11, 12 as shown in FIGS. 23 and 24. The handle 2 is then pivoted about the fixed bases 61 to the upright position “G” where the tail board 8 is parallel to the handle 2. The two wheel sets 3 that are located close to the tail board 8 are pivoted about the lateral tubes 13 to the in-use position “B”. The users my put goods on the trail board 8 and lean on the front and rear portions 11, 12, and transfer the goods by the upright cart.

The advantages of the present invention are that the handle 2, the front portion 11, the rear portion 12 and the wheel sets 3 are designed to be pivotable so as to set the cart in different statuses to meet different needs.

While we have shown and described the embodiment in accordance with the present invention, it should be clear to those skilled in the art that further embodiments may be made without departing from the scope of the present invention.

What is claimed is:

1. A multiple-function cart comprising:
a main body having a front portion and a rear portion which is pivotably connected to the front portion by a first pivotal unit, the front portion being pivotable relative to the rear portion by the first pivotal unit;
a handle pivotably connected to the rear portion by two second pivotal units, the handle being pivotable by the two second pivotal units;
four wheel sets respectively and pivotably connected to the front portion and the rear portion, each wheel set having a wheel and a wheel frame to which the wheel is connected, each wheel set being pivotable between a non-in-use position and an in-use position, when each of the wheel sets is located at the non-in-use position, the wheel sets are parallel with the main body and located at inside of the main body, when each of the wheel sets is located at the in-use position, the wheel sets are perpendicular to the main body;
a strap unit having a back board, the strap unit connected to the handle by one of two sides of the back board, a strap connected to the other of the two sides of the back board, and
a tail board pivotably connected to the front portion and located away from the rear portion, the tail board being pivotable toward the front portion, or being perpendicular to the front portion.

2. The multiple-function cart as claimed in claim 1, wherein each of the front portion and the rear portion includes two lateral tubes and two transverse tubes that transversely across the two lateral tubes.

3. The multiple-function cart as claimed in claim 1, wherein the wheel frame of each wheel set includes a first seat and a restriction part respectively connected to each latera tube, the wheel frame is pivotably located between the restriction part and the first seat, the restriction part includes at least two protrusions, the wheel frame includes at least two notches which are located corresponding to the at least two protrusions, a first spring is biased between the wheel frame and the first seat, the at least two protrusions are engaged with the at least two notches so as to set the wheel frame at the non-in-use position or the in-use position.

4. The multiple-function cart as claimed in claim 1, wherein the two transverse tube are two hollow tubes and each have an end hole in each of two ends thereof, at least one of the two transverse tubes has at least one positioning hole, four extension parts each have a lateral rod and two bars which extend from one side of the lateral rod, the extension parts are respectively located on two sides of the front portion and the rear portion, the bars are slidably inserted in the transverse tubes, one of the bars of each extension portion includes a positioning unit which is located corresponding to the at least one positioning hole.

5. The multiple-function cart as claimed in claim 4, wherein the positioning unit includes a positioning member and a pin, the positioning member includes a stop and an extension portion which is located away from the at least one positioning hole, the extension portion slidably mounted to the pin, a second spring is mounted to outside of the extension portion, the second spring biases the stop to push the positioning member to move along the pin and toward the at least one positioning hole, the stop is located at the at least one positioning hole, the stop includes a press portion which protrudes into the at least one positioning hole.

6. The multiple-function cart as claimed in claim 1, wherein the first pivotal unit includes four shafts, each shaft is pivotably connected to a second pivotal part, each second pivotal part is connected to the two lateral tube of the front portion and the two lateral tubes of the rear portion so that the front portion and the rear portion are respectively pivotable between an expanded position and a retrieved position by the second pivotal parts.

7. The multiple-function cart as claimed in claim 6, wherein each of the shafts has a positioning member fixed thereto which has two first bumps and second bumps which are located alternatively to the first bumps, a curve recess is formed between each of the first and second bumps, the two first bumps extend higher than the two second bumps and are located away from the shafts, each of the second pivotal parts includes two curve steel plates which are located corresponding to the curve recesses, when the second pivotal parts are pivoted about the shafts to the expanded position, the curve steel plates are located in the curve recesses and stopped by the first bumps, so that the second pivotal parts cannot pivot clockwise about the shafts, when the second pivotal parts are pivoted about the shafts to the retrieved position, the curve steel plates are located in the curve recesses and stopped by the first bumps, so that the second pivotal parts cannot pivot.

8. The multiple-function cart as claimed in claim 1, wherein the two second pivotal units of the handle are connected to the rear portion, each second pivotal unit includes a fixed base and a first pivotal part, the two fixed bases are respectively connected to the rear portion, the two first pivotal parts are respectively and pivotably connected to the two fixed bases and connected to the handle, the handle is pivotable about the two fixed bases.

9. The multiple-function cart as claimed in claim 8, wherein the two first pivotal parts each have a chamber defined therein, and two axial holes are respectively defined in two ends of each first pivotal part, the two axial holes communicate with the chamber, each fixed base includes an axle which is pivotably inserted into one of the two axial holes of the first pivotal part corresponding to the fixed base and is secured to a second seat in the chamber, each second seat has a button slidably mounted thereto, a third spring is biased between the button and the second seat so as to push a portion of the button beyond the other of the two axial holes, each button includes at least one lug extending radially therefrom, at least two dents are defined in an inner periphery of the chamber of each first pivotal part, when each of the first pivotal parts is pivoted about the axial of the fixed base corresponding thereto, the at least one lug is engaged with one of the at least two dents to set the handle at a folded position, a transverse position and a upright position.

10. The multiple-function cart as claimed in claim 1, wherein the first pivotal unit includes a room in which a restriction member and a fourth spring are received, the fourth spring biases the restriction member, the first pivotal unit includes two installation holes which communicate with the room, a support frame includes two legs which are inserted into the two installation holes, each leg includes a bore with which the restriction member is engaged when the leg is inserted into the installation hole corresponding thereto.

11. The multiple-function cart as claimed in claim 1, wherein the handle is a U-shaped handle and includes two connection tubes with a bridge connected between the two connection tubes, the two connection tubes are connected to the rear portion by the two second pivotal units, multiple loops are formed on each of the two connection tubes, the strap unit includes multiple hooks which are hooked to the loops.

12. The multiple-function cart as claimed in claim 1, wherein the front portion includes a positioning part pivotably connected to one side thereof, the positioning part has a first slot and a second slot, the rear portion includes a bolt which is connected to the first slot to set the front portion and the rear portion at the expanded position, when the bolt is connected to the second slot, the front portion and the rear portion are set at the retrieved position.
